(19) United States
(12) Patent Application Publication
(10) Pub. No.: US 2025/0315996 A1
(43) Pub. Date: Oct. 9, 2025

(54) HISTOGRAM-BASED RECOVERY OF POINT CLOUD ERRORS

(71) Applicant: Lumentum Operations LLC, San Jose, CA (US)

(72) Inventors: Jeremy PORQUEZ, Nepean (CA); Andrew James TELFORD, Ottawa (CA); Alan HNATIW, Stittsville (CA)

(21) Appl. No.: 18/739,755

(22) Filed: Jun. 11, 2024

Related U.S. Application Data
(60) Provisional application No. 63/574,015, filed on Apr. 3, 2024.

(51) Int. Cl. G06T 11/20; G01S 7/4865; G01S 17/08

(52) U.S. Cl. CPC G06T 11/206; G01S 7/4865; G01S 17/08

(57) ABSTRACT

An optical receiver includes an indirect time-of-flight sensor configured to receive a modulated optical signal from free-space, and generate a plurality of first distance values based on the modulated optical signal; and one or more processors configured to: generate a first histogram based on the plurality of first distance values, detect a first maximum peak within the first histogram, detect one or more first side peaks within the first histogram that are offset from the first maximum peak, for each first side peak: calculate a first number of wavelength distances that the first side peak is located from the first histogram location of the first maximum peak, and calculate a first corrected absolute distance of the first side peak based on the first number of wavelength distances, generate a first corrected histogram, corresponding to the first histogram, based on the first corrected absolute distance of each first side peak.

### CROSS-REFERENCE TO RELATED APPLICATION

This Patent application claims priority to U.S. Provisional Patent Application No. 63/574,015, filed on Apr. 3, 2024, and entitled “HISTOGRAM-BASED RECOVERY OF POINT CLOUD ERRORS.” The disclosure of the prior Application is considered part of and is incorporated by reference into this Patent Application.

### TECHNICAL FIELD

The present disclosure relates generally to beam scanning systems and methods for beam scanning.

### BACKGROUND

A scanning system may use two-dimensional (2D) or three-dimensional (3D) scanning to scan one or more light beams within a field-of-view (FOV) according to a scanning pattern. The scanning system may use two scanning axes, including a first scanning axis that is configured to steer the one or more light beams in a first direction at a first scanning frequency and a second scanning axis that is configured to steer the one or more light beams in a second direction at a second scanning frequency. The second scanning axis is typically perpendicular to the first scanning axis. Transmitted light beams may be reflected back to the scanning system from one or more objects in the FOV as reflected light beams. A 3D image, such as a point cloud, of a scanned scene or a scanned object can then be generated based on distance measurements corresponding to the transmitted/reflected light beams. Additionally, or alternatively, the reflected light beams may be used by the scanning system to detect objects within the FOV for further processing.

### SUMMARY

In some implementations, an optical ranging system includes a transmitter configured to transmit a modulated optical signal; an indirect time-of-flight sensor configured to receive a reflected optical signal, associated with the modulated optical signal, and generate a plurality of first distance values based on the reflected optical signal; and one or more processors configured to: generate a first histogram based on the plurality of first distance values, detect a first maximum peak within the first histogram, detect one or more first side peaks within the first histogram that are offset from the first maximum peak, wherein each first side peak is located at least a first wavelength distance from a first histogram location of the first maximum peak, for each first side peak: calculate a first number of first wavelength distances that the first side peak is located from the first histogram location of the first maximum peak, and calculate a first corrected absolute distance of the first side peak based on the first number of first wavelength distances, generate a first corrected histogram, corresponding to the first histogram, based on the first corrected absolute distance of each first side peak, and generate a point cloud based on the first corrected histogram.

In some implementations, an optical receiver includes an indirect time-of-flight sensor configured to receive a modulated optical signal from free-space, and generate a plurality of first distance values based on the modulated optical signal; and one or more processors configured to: generate a first histogram based on the plurality of first distance values, detect a first maximum peak within the first histogram, detect one or more first side peaks within the first histogram that are offset from the first maximum peak, wherein each first side peak is located at least a first wavelength distance from a first histogram location of the first maximum peak, for each first side peak: calculate a first number of first wavelength distances that the first side peak is located from the first histogram location of the first maximum peak, and calculate a first corrected absolute distance of the first side peak based on the first number of first wavelength distances, generate a first corrected histogram, corresponding to the first histogram, based on the first corrected absolute distance of each first side peak, and detect one or more objects in the free-space based on the first corrected histogram.

In some implementations, a method of correcting point cloud errors includes receiving a modulated optical signal from a field-of-view; generating a plurality of first distance values based on the modulated optical signal; generating a first histogram based on the plurality of first distance values; detecting a first maximum peak within the first histogram; detecting one or more first side peaks within the first histogram that are offset from the first maximum peak, wherein each first side peak is located at least a first wavelength distance from a first histogram location of the first maximum peak; for each first side peak: calculating a first number of first wavelength distances that the first side peak is located from the first histogram location of the first maximum peak; and calculating a first corrected absolute distance of the first side peak based on the first number of first wavelength distances; generating a first corrected histogram, corresponding to the first histogram, based on the first corrected absolute distance of each first side peak; and generating a point cloud based on the first corrected histogram.

### BRIEF DESCRIPTION OF THE DRAWINGS

FIG. 1A is a schematic block diagram of a 2D scanning system according to one or more implementations.

FIG. 1B is a schematic block diagram of a 2D scanning system according to one or more implementations.

FIG. 2A shows a point cloud of an object located at approximately 1.3 meters without correction.

FIG. 2B shows a histogram associated with the point cloud shown in FIG. 2A.

FIG. 2C shows a corrected point cloud of an object located at approximately 1.3 meters after correction.

FIG. 2D shows a corrected histogram associated with the corrected point cloud shown in FIG. 2C.

FIG. 2E shows a corrected point cloud of an object located at approximately 1.3 meters after further correction.

FIG. 2F shows a corrected histogram associated with the corrected point cloud shown in FIG. 2E.

FIG. 3 is a flowchart of an example process associated with histogram-based recovery of point cloud errors.

### DETAILED DESCRIPTION

The following detailed description of example implementations refers to the accompanying drawings. The same reference numbers in different drawings may identify the same or similar elements.

In 3D sensing and imaging technologies, such as light detection and ranging (LIDAR), a scan can be performed to illuminate an area referred to as a field-of-view. For example, a scanning mirror may be arranged to receive transmitted light beams from a light transmitter and steer (scan) the transmitted light beams into the field-of-view to perform a scanning of the environment. The transmitted light beams may be backscattered by one or more objects back toward the scanning system as reflected light beams, where the reflected light beams are detected by a sensor. The sensor may convert a reflected light beam into an electrical signal (e.g., a current signal or a voltage signal) that may represent a distance measurement and may be further processed by the scanning system to generate object data or an image. For example, a vector of a transmitted light beam may be combined with a distance measurement to determine a point in a 3D point cloud, and the 3D point cloud may be generated based on a plurality of distance measurements acquired during a scanning operation.

An approach to performing a dimensional metrology is to use an optically coherent sensor that encodes multiple radio frequency (RF) tones onto a transmitted optical carrier and acquires reflected/scattered optical signals with different levels of distance accuracies in a distance range of meters (coarse) to microns (fine). For example, a coarse distance measurement may be performed using a lowest frequency tone, and a fine distance measurement may be performed using a highest frequency tone. Accurate distance measurements can be obtained by precisely determining a phase difference for each of these tones relative to a reference signal, where the shorter the wavelength of the tones, the higher the precision of the instrument. Utilizing an indirect time-of-flight method, such as frequency modulation continuous wave (FMCW) or amplitude modulation continuous wave (AMCW), accurate distance measurements can be obtained by precisely determining a phase of each returned tone relative to a corresponding transmitted tone. In other words, a distance measurement is encoded onto a phase difference between a phase of a reflected tone and a phase of a transmitted tone.

A problem arises when a signal-to-noise ratio (SNR) of one of the received tones becomes too low, such that a calculated location of the point in a point cloud lands at a wrong location. This occurs because each tone is a periodic signal which corresponds to a periodic distance (e.g., the phase can go through multiples of 2π). Thus, it may be desirable to reduce the noise of a distance measurement in order to improve measurement precision.

Some implementations provide a beam scanning system that is configured to combine a working principle of an indirect time-of-flight sensor, such as a multi-tone coherent sensor, with a histogram-based analysis of point cloud data to correct point cloud errors and improve overall distance measurement precision.

Point cloud errors may be corrected by taking a histogram of a point cloud data set versus a target distance and making a correction for lost tones generated by the indirect time-of-flight sensor. One or more processors may be configured to analyze a distribution of points within the histogram and compare the distribution of points to a median value. If there are large concentrations of data at a distance corresponding to a wavelength period, the data can be relocated or moved to a main peak withing the histogram. This, in effect, is a post-processing error correction technique. A histogram may be generated for each tone. Thus, the correction may be performed for each histogram (e.g., for each tone) in order to correct point cloud errors associated with each tone.

The one or more processors may execute a post-processing error correction algorithm to correct the point cloud errors. A method of performing post-processing error corrections may include obtaining an absolute distance histogram of a point cloud dataset, and determining, from the absolute distance histogram, a location within the absolute distance histogram of a highest density rₘₐₓ. The location of the highest density rₘₐₓ may be an absolute distance at which the highest density occurs.

For each tone of the multiple RF tones encoded onto the optical signal, in a direction or order of decreasing wavelengths (increasing frequencies): the method may include calculating peak locations with a constraint that (absolute) peak distances should be greater than or equal to a tone wavelength of an i^{th} tone, calculating a number of tone lengths m that the each of peak locations are away from rₘₐₓ, calculate a desired new absolute distance r_{new}=rₚᵣₑᵥ−m×dᵢ, where rₚᵣₑᵥ is a previous absolute distance, m is the number of tone lengths away from rₘₐₓ, dᵢ is a wavelength of the i^{th} tone, and i is an integer greater than zero. Once the new absolute distance r_{new} is calculated, the one or more processors may generate new positions x, y, and z for each point in the point cloud dataset using the formula:

u_{new}=(uₚᵣₑᵥ×r_{new})/rₚᵣₑᵥ,

where u_{new} is a new position for each coordinate x,y,z, uₚᵣₑᵥ is a previous position for each coordinate x,y,z, r_{new} is the new absolute distance, and rₚᵣₑᵥ is the previous absolute distance of the point.

Additionally, the algorithm described herein may be used to train a neural network, and then the algorithm may be encoded and implemented by the neural network.

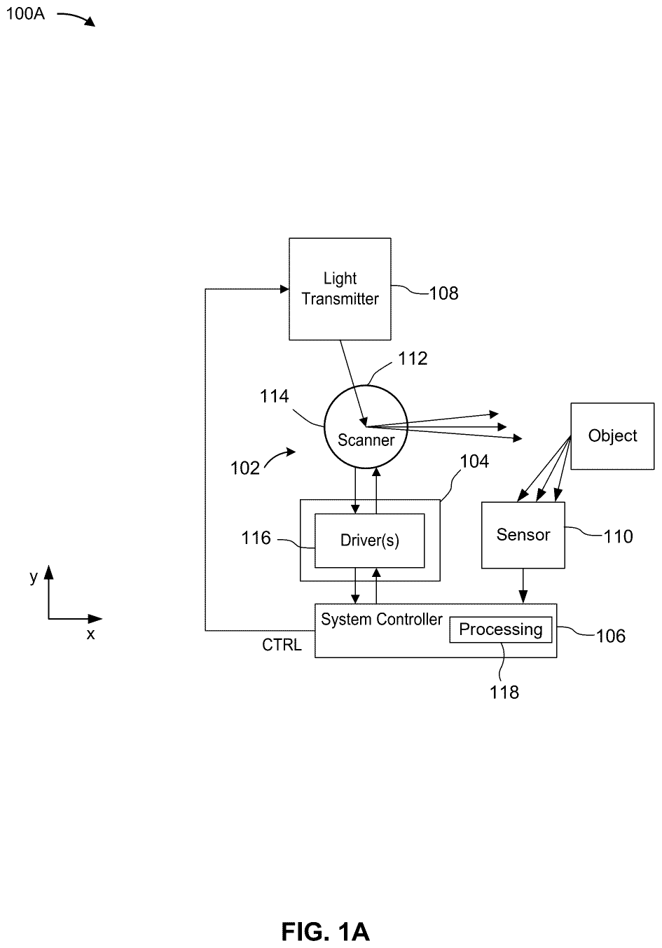

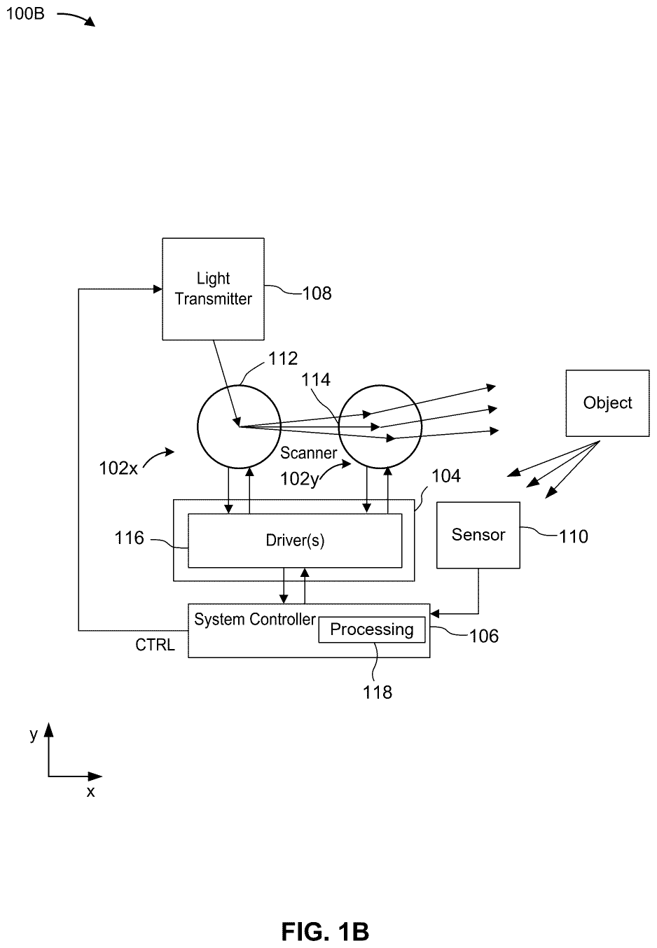

FIG. 1A is a schematic block diagram of a 2D scanning system 100A according to one or more implementations. In particular, the 2D scanning system 100A includes a scanner 102 configured to steer or otherwise deflect light beams according to a 2D scanning pattern for scanning 3D objects. The 2D scanning system 100A further includes a driver system 104, a system controller 106, and a light transmitter 108, and a sensor 110.

In the example shown in FIG. 1A, the scanner 102 may be a mechanical moving mirror and may be configured to rotate or oscillate via rotation about two scanning axes that are typically orthogonal to each other. For example, the two scanning axes may include a first scanning axis 112 that enables the scanner 102 to steer light in a first scanning direction (e.g., an x-direction) and a second scanning axis 114 (e.g., an inner scanning axis) that enables the scanner 102 to steer light in a second scanning direction (e.g., a y-direction). As a result, the scanner 102 can direct light beams in two dimensions according to the 2D scanning pattern.

A scan can be performed to illuminate an area referred to as a field-of-view. The scan, such as an oscillating horizontal scan (e.g., from left to right and right to left of a field-of-view), an oscillating vertical scan (e.g., from bottom to top and top to bottom of a field-of-view), or a combination thereof (e.g., a Lissajous scan or a raster scan) can illuminate the field-of-view in a continuous scan fashion. In some implementations, the 2D scanning system 100A may be configured to transmit a light beam as a modulated optical signal (e.g., a continuous-wave light beam) in different scanning directions to scan the field-of-view. The scanner 102 can direct a transmitted light beam at a desired 2D measurement coordinate (e.g., an x-y coordinate or vector) in the field-of-view, controlled by the system controller 106.

For continuous wave modulation, such as that used for an AMCW beam, a delay of a detected wave after reflection is measured at a receiver. In the case of AMCW, an intensity pattern (e.g., an RF signal) may be encoded on a transmitted optical power of an optical signal, such as a linear RF chirp, a single frequency sine wave, or a multi-frequency sine wave generated by a local oscillator. Thus, the modulated optical signal may be an RF-encoded optical signal comprising a plurality of RF signal components, wherein each RF signal component has a different frequency (e.g., a different tone). For AMCW, a free-space path encodes a phase shift on the RF signal, which can be detected by measuring an intermediate frequency after mixing a received intensity signal with a non-delayed electronic version of the transmitted RF signal (e.g., a local oscillator signal). Thus, a distance can be determined from a measured phase shift.

In some implementations, the scanner 102 may be arranged to receive a transmitted light beam from the light transmitter 108 and steer (scan) the transmitted light beam into the field-of-view to perform a scanning of the environment. The transmitted light beams may be backscattered by one or more objects back toward the 2D scanning system 100A as reflected light beams, where the reflected light beams are detected by the sensor 110. For example, the sensor 110 may be an indirect time-of-flight sensor that includes a photodetector array. The sensor 110 may convert each reflected light beam into an electrical signal (e.g., a current signal or a voltage signal) that may be further processed by the 2D scanning system 100A to generate object data or an image. Thus, the sensor 110 may be configured to receive a reflected light beam, and generate one or more distance measurements based on the reflected light beam and an indirect time-of-flight measurement principle (e.g., based on a FMCW measurement principle or an AMCW measurement principle). In some implementations, the sensor 110 may generate a plurality of distance values based on respective phase differences between the reflected light beam and a reference signal (e.g., a corresponding tone generated by the local oscillator). For example, the sensor 110 may use coherent optical detection to generate the plurality of distance values.

In such implementations, the desired 2D measurement coordinate may correspond to a particular transmission direction or vector in the field-of-view that is targeted by the transmitted light beam for object detection or scanning, with different 2D measurement coordinates corresponding to different transmission directions. The system controller 106 may receive electrical signals from the sensor and perform signal processing on the electrical signals for object feature detection.

Accordingly, the transmitted light beam can be steered by the scanner 102 at the different 2D measurement coordinates of the field-of-view in accordance with the 2D scanning pattern. The scanner 102 can be used to scan the field-of-view in both scanning directions by changing an angle of deflection of the scanner 102 on each of the first scanning axis 112 and the second scanning axis 114.

The driver system 104 may be configured to generate driving signals (e.g., actuation signals) to drive the scanner 102 about the first scanning axis 112 and the second scanning axis 114. In particular, the driver system 104 may be configured to apply the driving signals to an actuator structure of the scanner 102. In some implementations, the driver system 104 includes a driver 116 configured to drive the scanner 102 about the first scanning axis 112 and the second scanning axis 114. The scanner 102 may have separate actuator structures for each scanning axis. Thus, the scanner 102 may have a first actuator structure for the first scanning axis 112, and a second actuator structure for the second scanning axis 114. The driver 116 may apply a first driving signal to the first actuator structure to drive the scanner 102 about the first scanning axis, and may apply a second driving signal to the second actuator structure to drive the scanner 102 about the second scanning axis. In some implementations, the driver 116 may include separate drivers for each scanning axis 112 and 114. In implementations in which the scanner 102 is used as an oscillator, the driver 116 may be configured to drive an oscillation of the scanner 102 about the first scanning axis 112 at a first frequency, and drive an oscillation of the scanner 102 about the second scanning axis 114 at a second frequency.

The driver 116 may be configured to receive feedback information from the scanner 102, such as rotational position information (e.g., an angle measurement). The system controller 106 may use the rotational position information to generate point cloud data. For example, the system controller 106 may receive distance measurements from the sensor 110 and rotational position information associated with the scanner 102, and generate the point cloud data based on the distance measurements and the rotational position information.

In some implementations, the system controller 106 is configured to set a driving frequency of the scanner 102 for each scanning axis and is capable of synchronizing the oscillations about the first scanning axis 112 and the second scanning axis 114. In particular, the system controller 106 may be configured to control an actuation of the scanner 102 about each scanning axis by controlling the driving signals. The system controller 106 may control the frequency, the phase, the duty cycle, and/or a voltage level of the driving signals to control the actuations about the first scanning axis 112 and the second scanning axis 114. The actuation of the scanner 102 about a particular scanning axis controls its range of motion and scanning rate about that particular scanning axis.

The light transmitter 108 may include one or more light sources, such as one or more laser diodes or one or more light emitting diodes, for generating one or more light beams. In some implementations, the light transmitter 108 may be configured to modulate an optical signal with the plurality of RF signal components to transmit a continuous light beam as the scanner 102 changes its transmission direction in order to target different 2D measurement coordinates. A modulation of the optical signal may be implemented by the light transmitter 108 according to a control signal CTRL received from the system controller 106.

The system controller 106 may be configured to control components of the 2D scanning system 100A. In certain applications, the system controller 106 may also be configured to receive programming information with respect to the 2D scanning pattern and/or a modulation pattern, and control the modulation of the optical signal by the light transmitter 108 based on the programming information. Thus, the system controller 106 may include both processing and control circuitry that is configured to generate control signals for controlling the light transmitter 108 and the driver 116. For example, the system controller 106 may include processing circuitry 118 configured to execute machine instructions, and, based on executing the machine instructions, generate control signals for controlling the 2D scanning system 100A to perform a 2D scan of the scanning area according to the 2D scanning pattern. Thus, the processing circuitry 118 may include one or more processors and other signal processing components. In some implementations, the processing circuitry 118 may include a field-programmable gate array (FPGA) and/or a digital signal processor (DSP).

The processing circuitry 118, in conjunction with control circuitry, may control the light transmitter 108 and the scanner 102 to target each 2D measurement coordinate with the light beam. The processing circuitry 118 may control the scanner 102 by controlling one or more parameters of the driver 116, such as the frequency, the phase, the duty cycle, and/or a voltage level of the driving signals used for driving each scanning axis 112 and 114. The processing circuitry 118 may process a plurality of measurements signals and generate a 3D point cloud based on the plurality of measurement signals.

Accordingly, the 2D scanning system 100A may include a detector that includes at least one sensor (e.g., sensor 110) and at least one signal processor (e.g., the processing circuitry 118 or other additional processors and/or processing components) implemented, for example, in the system controller 106. The sensor 110 may generate electrical signals based on reflected light beams corresponding to the light beams transmitted by the light transmitter 108. The sensor 110 may transmit the electrical signals to processing circuitry 118. The processing circuitry 118 may be configured to process the electrical signals to generate distance measurements based on the machine instructions for generating the 3D point cloud.

The processing circuitry 118 may be configured to correct point cloud errors to improve overall distance measurement precision and to generate a more accurate 3D point cloud, which may enable more accurate object detection. As described above, the light transmitter 108 may transmit a modulated optical signal. The modulated optical signal may be an RF-encoded optical signal comprising a plurality of RF signal components, wherein each RF signal component has a different frequency (e.g., a different tone). For example, the modulated optical signal may be modulated with a first frequency such that the first frequency encoded onto the modulated optical signal. In addition, the modulated optical signal may be modulated with a second frequency such that the second frequency encoded onto the modulated optical signal. In some implementations, the modulated optical signal may be modulated with a third frequency such that the third frequency encoded onto the modulated optical signal. In some implementations, the first frequency may correspond to a coarse frequency tone, the second frequency may correspond to a mid-frequency tone, and the third frequency may correspond to a fine frequency tone.

The sensor 110 may generate a plurality of first distance values based on the reflected optical signal, where the plurality of first distance values correspond to the first frequency encoded onto the modulated optical signal. The reflected optical signal may be reflected modulated optical signal received from free-space. The plurality of first distance values may correspond to phase differences between the reflected optical signal and the coarse frequency tone of the transmitted signal. Each first distance value may correspond to a different sampling time, and thus a different measurement vector. Similarly, the sensor 110 may generate a plurality of second distance values based on the reflected optical signal, where the plurality of second distance values correspond to the second frequency encoded onto the modulated optical signal. Similarly, the sensor 110 may generate a plurality of third distance values based on the reflected optical signal, where the plurality of third distance values correspond to the third frequency encoded onto the modulated optical signal.

The processing circuitry 118 may generate an absolute distance histogram for each frequency and may correct point cloud errors in each absolute distance histogram. Thus, each absolute distance histogram may be representative of a point cloud dataset of a particular frequency that is encoded onto the modulated optical signal. Because the distance measurements are acquired over time, each absolute distance histogram may be a time-domain histogram.

The processing circuitry 118 may generate a first histogram based on the plurality of first distance values, detect a first maximum peak within the first histogram, and determine a first histogram location rₘₐₓ of the first maximum peak. The first histogram location Imax of the first maximum peak may be an absolute distance (e.g., a histogram distance) at which a highest density of first distance values occurs within the first histogram. Thus, the first maximum peak may be associated with the highest density of first distance values within the first histogram.

In addition, the processing circuitry 118 may detect one or more first side peaks within the first histogram that are offset from the first maximum peak. Each first side peak is located at least a first wavelength distance d1 from the first histogram location Imax of the first maximum peak. The first wavelength distance d1 is equal to a wavelength of the first frequency. In some implementations, each first side peak is located at a first respective integer multiple of the first wavelength distance d1 from the first histogram location Imax of the first maximum peak, where each first respective integer multiple is non-zero. For example, two first side peaks may be located on either side of the first histogram location Imax at absolute distances equal to the first wavelength distance d1. In addition, two first side peaks may be located on either side of the first histogram location Imax at absolute distances equal to twice the first wavelength distance d1. In addition, two first side peaks may be located on either side of the first histogram location Imax at absolute distances equal to triple the first wavelength distance d1. The processing circuitry 118 may determine an initial absolute distance rₚᵣₑᵥ of each first side peak.

For each first side peak, the processing circuitry 118 may calculate a first number of first wavelength distances m that the first side peak is located from the first histogram location of the first maximum peak, and calculate a first corrected absolute distance r_{new} of the first side peak based on the first number of first wavelength distances m. The processing circuitry 118 may calculate first corrected absolute distance r_{new} by calculating a compensation distance by multiplying the first number of wavelength distances m that the first side peak is located from the first histogram location rₘₐₓ by the first wavelength distance d1 (e.g., compensation distance=m×dᵢ), and subtracting the compensation distance from the initial absolute distance rₚᵣₑᵥ to calculate the first corrected absolute distance r_{new} of the first side peak. Thus, the first corrected absolute distance r_{new} may be calculated according to Equation 1:

r_{new}=rₚᵣₑᵥ−m×dᵢ Eq. 1,

where i represents the i^{th} frequency tone.

The processing circuitry 118 may generate a first corrected histogram, corresponding to the first histogram, based on the first corrected absolute distance of each first side peak. For example, the distance values corresponding to each first side peak may be repositioned within the first corrected histogram with according to its first corrected absolute distance r_{new} (e.g., substituting the initial absolute distance rₚᵣₑᵥ with the first corrected absolute distance r_{new}). The processing circuitry 118 may generate a point cloud based on the first corrected histogram.

In some implementations, the processing circuitry 118 may determine a corrected 3D coordinate (x, y, and z) for each measurement point in a point cloud dataset based on the first corrected histogram, and generate the point cloud based on the corrected 3D coordinate of each measurement point. For example, for each first side peak, the processing circuitry 118 may determine the corrected 3D coordinate for each measurement point associated with the first side peak based on the first corrected absolute distance r_{new} of the first side peak, where each measurement point is part of a point cloud dataset, and generate the point cloud based on the corrected 3D coordinate of each measurement point. The processing circuitry 118 may generate new positions x, y, and z for each point in the point cloud dataset based on Equation 2:

u_{new}=(uₚᵣₑᵥ×r_{new})/rₚᵣₑᵥ Eq. 2,

where u_{new} is a new (corrected) position for each 3D coordinate x,y,z, and uₚᵣₑᵥ is a previous position for each 3D coordinate x,y,z.

The processing circuitry 118 may repeat the error correction for each additional frequency (e.g. for each additional absolute distance histogram). The processing circuitry 118 may first correct the point cloud errors in the absolute distance histogram associated with the smallest frequency (e.g., the first frequency), then correct the point cloud errors in the absolute distance histogram associated with the next largest frequency, then correct the point cloud errors in the absolute distance histogram associated with the next largest frequency, and so on.

For example, the processing circuitry 118 may generate a second histogram based on the plurality of second distance values, detect a second maximum peak within the second histogram, and detect one or more second side peaks within the second histogram that are offset from the second maximum peak, where each second side peak is located at least a second wavelength distance d2 from a second histogram location rₘₐₓ of the second maximum peak. The second wavelength distance d2 is equal to a wavelength of the second frequency. In some implementations, each second side peak is located at a second respective integer multiple of the second wavelength distance d2 from the second histogram location rₘₐₓ of the second maximum peak, where each second respective integer multiple is non-zero.

For each second side peak, the processing circuitry 118 may calculate a second number of wavelength distances that the second side peak is located from the second histogram location of the second maximum peak, and calculate a second corrected absolute distance r_{new} of the second side peak based on the second number of wavelength distances, as similarly described above in connection with Equation 1. Additionally, the processing circuitry 118 may generate a second corrected histogram, corresponding to the second histogram, based on the second corrected absolute distance r_{new} of each second side peak, and generate the point cloud based on the first corrected histogram and the second corrected histogram.

In some implementations, the processing circuitry 118 may determine a corrected 3D coordinate (x, y, and z) for each measurement point in a point cloud dataset based on the second corrected histogram, and generate the point cloud based on the corrected 3D coordinate of each measurement point, as similarly described above in connection with Equation 2.

The processing circuitry 118 may generate a third histogram based on the plurality of third distance values, and repeat the error correction for the third frequency.

In some implementations, the processing circuitry 118 may detect one or more objects in the free-space based on the corrected histograms, and/or based on a final 3D point cloud generated from the corrected histograms.

As indicated above, FIG. 1A is provided as an example. Other examples may differ from what is described with regard to FIG. 1A. In practice, the 2D scanning system 100A may include additional components, fewer components, different components, or differently arranged components than those shown in FIG. 1A without deviating from the disclosure provided above.

FIG. 1B is a schematic block diagram of a 2D scanning system 100B according to one or more implementations. In particular, the 2D scanning system 100B includes two scanners, a first scanner 102x and a second scanner 102y, that are optically coupled in series to steer or otherwise deflect light beams according to a 2D scanning pattern. The first scanner 102x and the second scanner 102y are similar to the scanner 102 described in FIG. 1A, with the exception that the first scanner 102x and the second scanner 102y are configured to rotate about a single scanning axis instead of two scanning axes. The first scanner 102x is configured to rotate about the first scanning axis 112 to steer light in the x-direction, and the second scanner 102y is configured to rotate about the second scanning axis 114 to steer light in the y-direction.

Because each of the first scanner 102x and the second scanner 102y is configured to rotate about a single scanning axis, each of the first scanner 102x and the second scanner 102y is responsible for scanning light in one dimension. As a result, the first scanner 102x and the second scanner 102y may be referred to as one-dimensional (1D) scanner. In the example shown in FIG. 1B, the first scanner 102x and the second scanner 102y are used together to steer light beams in two dimensions. The first scanner 102x and the second scanner 102y are arranged sequentially along a transmission path of the light beams such that one of the scanners (e.g., the first scanner 102x) first receives a light beam and steers the light beam in a first dimension, and the second one of the scanners (e.g., the second scanner 102y) receives the light beam from the first scanner 102x and steers the light beam in a second dimension. As a result, the first scanner 102x and the second scanner 102y operate together to steer the light beam generated by the light transmitter 108 in two dimensions. In this way, the first scanner 102x and the second scanner 102y can direct the light beam at a desired 2D coordinate (e.g., an x-y coordinate or vector) in the field-of-view. The light beam can be steered by the first scanner 102x and the second scanner 102y at different 2D coordinates of a 2D scanning pattern.

The driver system 104, the system controller 106, and the light transmitter 108 are configured to operate as similarly described above in reference to FIG. 1A. The driver 116 may be electrically coupled to the first scanner 102x to drive the first scanner 102x about the first scanning axis 112, and the driver system 104 may detect a position (e.g., an angular position) of the first scanner 102x about the first scanning axis 112 to provide first position information to the system controller 106. Similarly, the driver 116 may be electrically coupled to the second scanner 102y to drive the second scanner 102y about the second scanning axis 114, and the driver system 104 may detect a position (e.g., an angular position) of the second scanner 102y about the second scanning axis 114 to send a position of the second scanner 102y about the second scanning axis 114 to provide second position information to the system controller 106.

The system controller 106 may generate corrected histograms for each frequency used to modulate the transmitted light beam in a similar manner described in connection with FIG. 1A. In other words, the processing circuitry 118 may be functionally equivalent to the processing circuitry 118 described in connection with FIG. 1A.

As indicated above, FIG. 1B is provided as an example. Other examples may differ from what is described with regard to FIG. 1B. In practice, the 2D scanning system 100B may include additional components, fewer components, different components, or differently arranged components than those shown in FIG. 1B without deviating from the disclosure provided above.

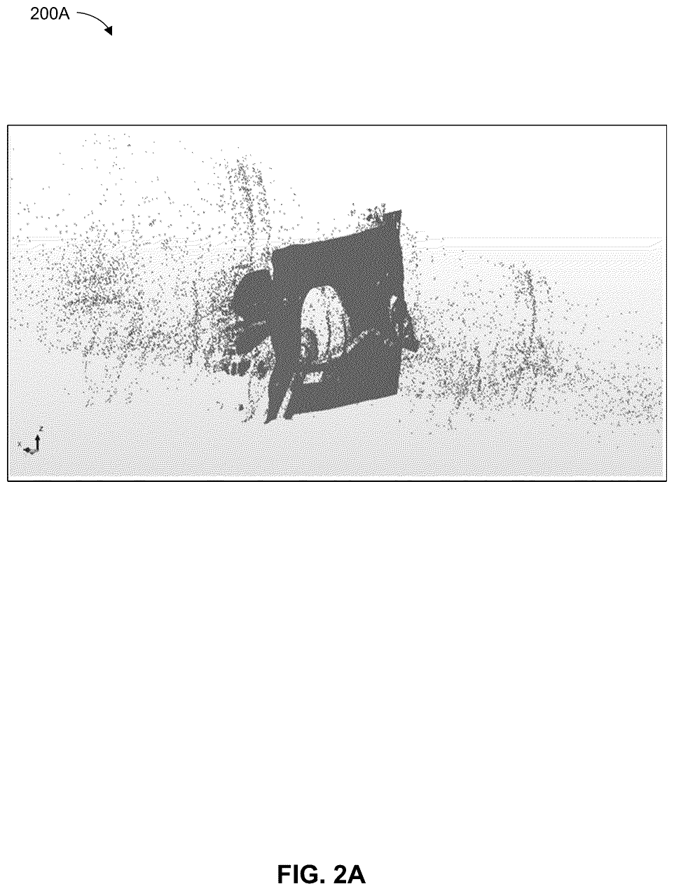

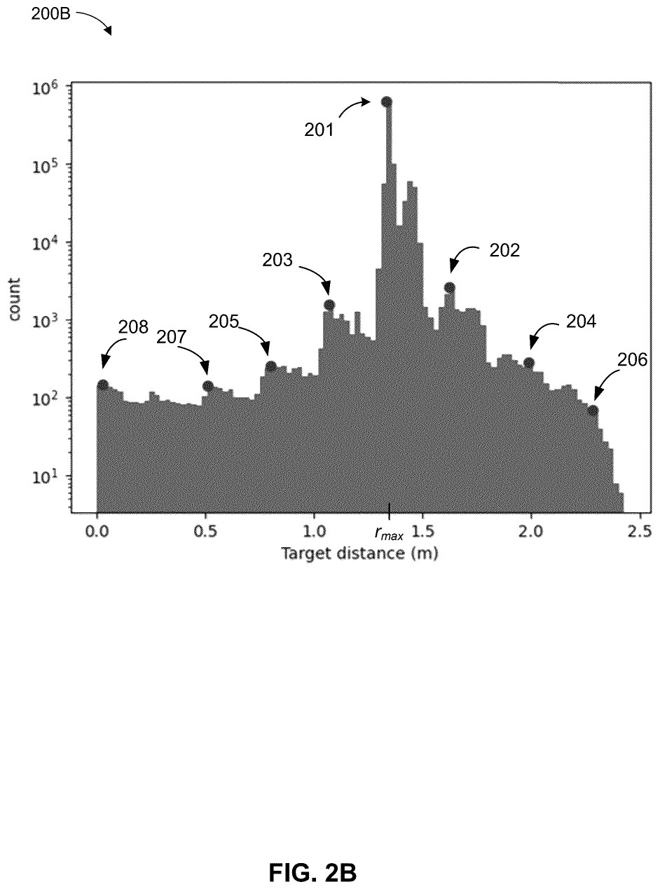

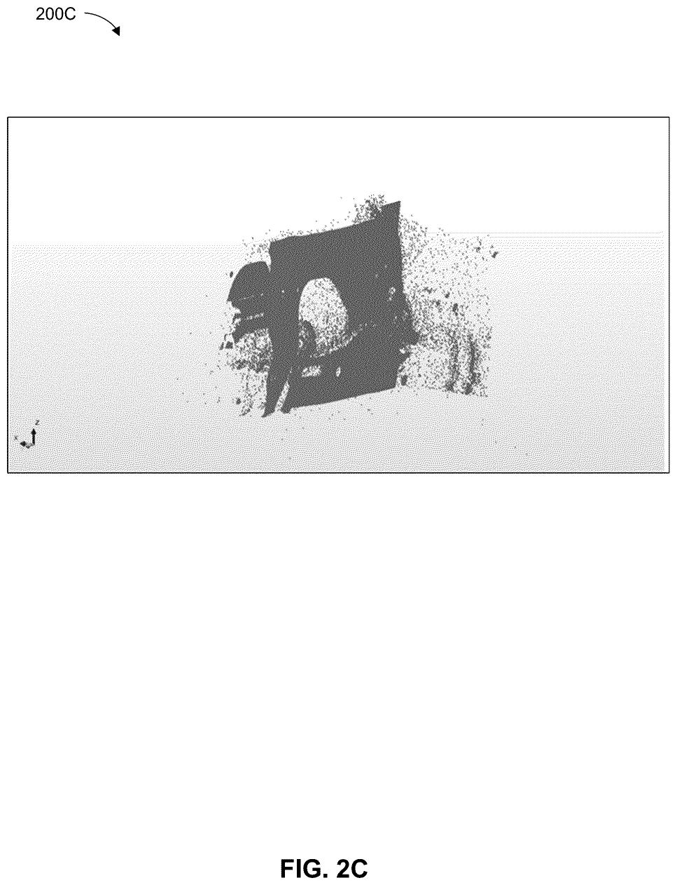

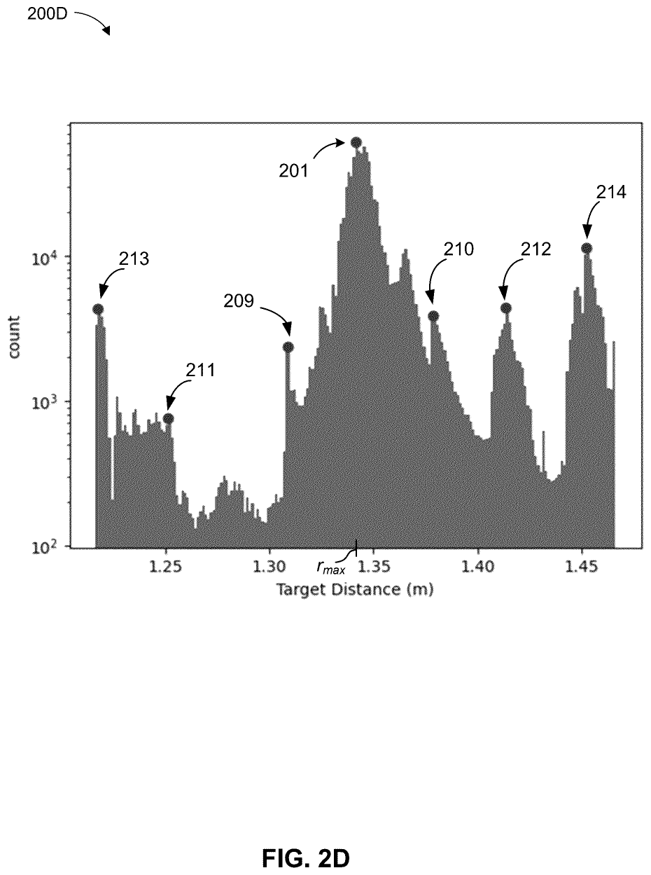

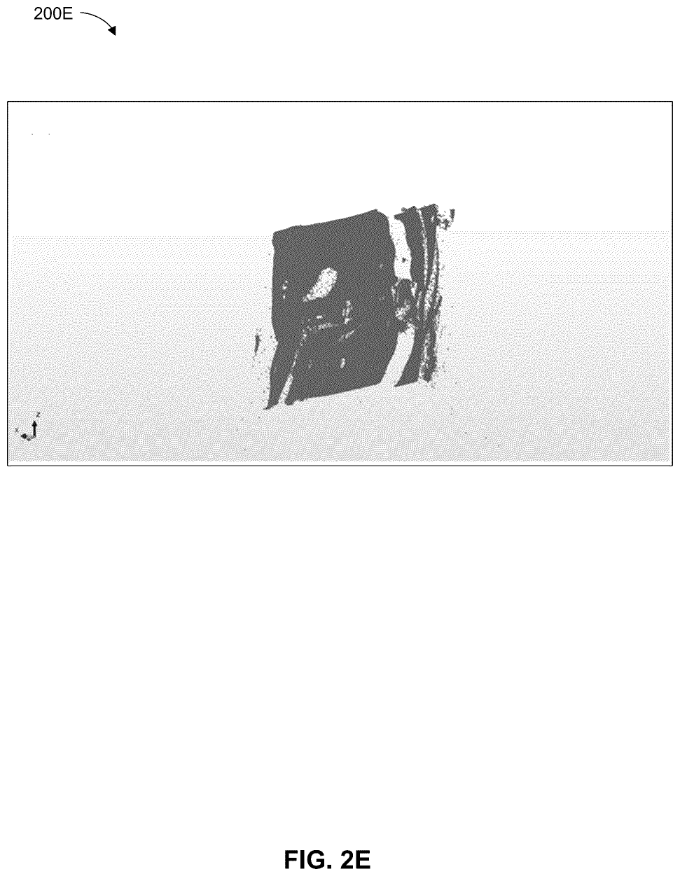

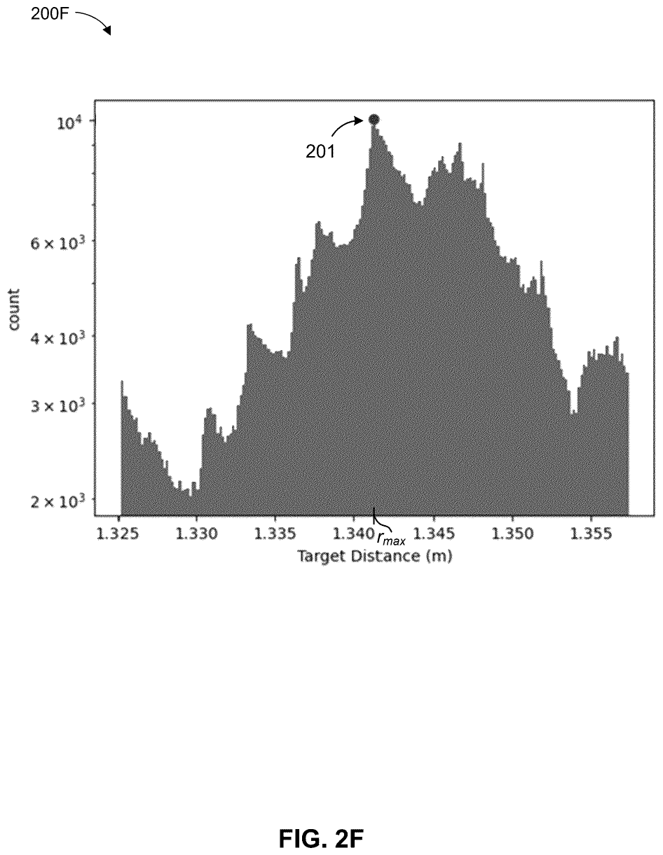

FIG. 2A shows a point cloud 200A of an object located at approximately 1.3 meters without correction. The point cloud 200A may be associated with the first frequency and may be generated based on the first plurality of distance values. A large number of point cloud errors exist due to noise, which cause a burring, scattering, or ghosting effect. as a result, point cloud image of the object is not clear.

As indicated above, FIG. 2A is provided as an example. Other examples may differ from what is described with regard to FIG. 2A.

FIG. 2B shows a histogram 200B associated with the point cloud 200A shown in FIG. 2A. Thus, the histogram 200B includes the same point cloud errors present in the point cloud 200A. The maximum peak 201 may be detected at approximately 1.3 meters, with a histogram location denoted rₘₐₓ. In addition, side peaks 202-208 may be detected within the histogram 200B that are offset from the maximum peak 201. Each side peak 202-208 may have a respective initial absolute distance rₚᵣₑᵥ, which may be corrected to a respective corrected absolute distance r_{new}, based on Equation 1. Each side peak 202-208 is located at least a wavelength distance from a histogram location rₘₐₓ of the maximum peak 201.

As indicated above, FIG. 2B is provided as an example. Other examples may differ from what is described with regard to FIG. 2B.

FIG. 2C shows a corrected point cloud 200C of an object located at approximately 1.3 meters after correction. The corrected point cloud 200C may be a corrected version of the point cloud 200A. Due to correction of point cloud errors (e.g., a corrected point cloud dataset) present in the point cloud 200A, the corrected point cloud 200C provides a sharper, more accurate representation of the object.

As indicated above, FIG. 2C is provided as an example. Other examples may differ from what is described with regard to FIG. 2C.

FIG. 2D shows a corrected histogram 200D associated with the corrected point cloud 200C shown in FIG. 2C. Thus, the corrected histogram 200D includes corrected measurement points (e.g. corrected distance values) calculated based on Equation 1. As a result of the correction, new side peaks emerge 209-214 (or become more accurately defined), and the histogram location rₘₐₓ of the maximum peak 201 becomes more accurate.

As indicated above, FIG. 2D is provided as an example. Other examples may differ from what is described with regard to FIG. 2D.

FIG. 2E shows a corrected point cloud 200E of an object located at approximately 1.3 meters after further correction. The corrected point cloud 200E may be associated with the second frequency or the third frequency and may be generated based on the second or third plurality of distance values. Due to correction of point cloud errors (e.g., a corrected point cloud dataset) present in the second or third histogram, the corrected point cloud 200E provides a sharper, more accurate representation of the object.

As indicated above, FIG. 2E is provided as an example. Other examples may differ from what is described with regard to FIG. 2E.

FIG. 2F shows a corrected histogram 200F associated with the corrected point cloud 200E shown in FIG. 2E. Thus, the corrected histogram 200F includes corrected measurement points (e.g. corrected distance values) calculated based on Equation 1. As a result of the correction, new side peaks emerge (or become more accurately defined), and the histogram location rₘₐₓ of the maximum peak 201 becomes more accurate.

As indicated above, FIG. 2F is provided as an example. Other examples may differ from what is described with regard to FIG. 2F.

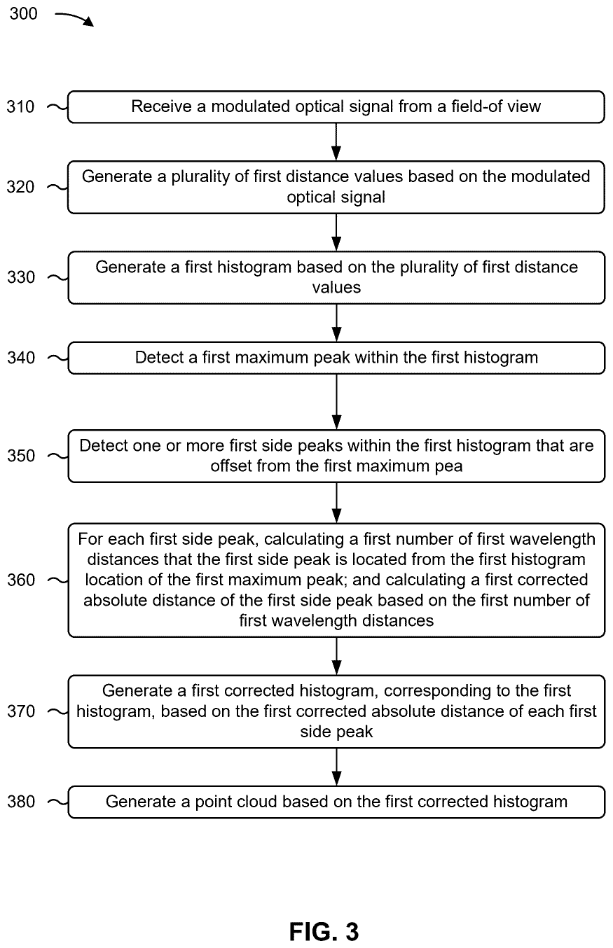

FIG. 3 is a flowchart of an example process 300 associated with histogram-based recovery of point cloud errors. In some implementations, one or more process blocks of FIG. 3 are performed by a system controller (e.g., system controller 106). In some implementations, one or more process blocks of FIG. 3 are performed by another device or a group of devices separate from or including the system controller, such as an indirect time-of-flight sensor (e.g., sensor 110), a light transmitter (e.g., light transmitter 108), and/or processing circuitry (e.g., processing circuitry 118).

As shown in FIG. 3, process 300 may include receiving a modulated optical signal from a field-of-view (block 310). For example, the sensor 110 may receive a modulated optical signal from a field-of-view, as described above.

As further shown in FIG. 3, process 300 may include generating a plurality of first distance values based on the modulated optical signal (block 320). For example, the sensor 110 may generate a plurality of first distance values based on the modulated optical signal, as described above.

As further shown in FIG. 3, process 300 may include generating a first histogram based on the plurality of first distance values (block 330). For example, one or more processors may generate a first histogram based on the plurality of first distance values, as described above.

As further shown in FIG. 3, process 300 may include detecting a first maximum peak within the first histogram (block 340). For example, one or more processors may detect a first maximum peak within the first histogram, as described above.

As further shown in FIG. 3, process 300 may include detecting one or more first side peaks within the first histogram that are offset from the first maximum peak (block 350). For example, one or more processors may detect one or more first side peaks within the first histogram that are offset from the first maximum peak, where each first side peak is located at least a first wavelength distance from a first histogram location of the first maximum peak, as described above.

As further shown in FIG. 3, process 300 may include, for each first side peak: calculating a first number of first wavelength distances that the first side peak is located from the first histogram location of the first maximum peak; and calculating a first corrected absolute distance of the first side peak based on the first number of first wavelength distances (block 360). For example, one or more processors may, for each first side peak: calculating a first number of first wavelength distances that the first side peak is located from the first histogram location of the first maximum peak; and calculating a first corrected absolute distance of the first side peak based on the first number of first wavelength distances, as described above.

As further shown in FIG. 3, process 300 may include generating a first corrected histogram, corresponding to the first histogram, based on the first corrected absolute distance of each first side peak (block 370). For example, one or more processors may generate a first corrected histogram, corresponding to the first histogram, based on the first corrected absolute distance of each first side peak, as described above.

As further shown in FIG. 3, process 300 may include generating a point cloud based on the first corrected histogram (block 380). For example, one or more processors may generate a point cloud based on the first corrected histogram, as described above.

Process 300 may include additional implementations, such as any single implementation or any combination of implementations described below and/or in connection with one or more other processes described elsewhere herein.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

The following provides an overview of some Aspects of the present disclosure:

Aspect 1: An optical ranging system, comprising: a transmitter configured to transmit a modulated optical signal; an indirect time-of-flight sensor configured to receive a reflected optical signal, associated with the modulated optical signal, and generate a plurality of first distance values based on the reflected optical signal; and one or more processors configured to: generate a first histogram based on the plurality of first distance values, detect a first maximum peak within the first histogram, detect one or more first side peaks within the first histogram that are offset from the first maximum peak, wherein each first side peak is located at least a first wavelength distance from a first histogram location of the first maximum peak, for each first side peak: calculate a first number of first wavelength distances that the first side peak is located from the first histogram location of the first maximum peak, and calculate a first corrected absolute distance of the first side peak based on the first number of first wavelength distances, generate a first corrected histogram, corresponding to the first histogram, based on the first corrected absolute distance of each first side peak, and generate a point cloud based on the first corrected histogram.

Aspect 2: The optical ranging system of Aspect 1, wherein the first maximum peak is associated with a highest density of first distance values within the first histogram.

Aspect 3: The optical ranging system of any of Aspects 1-2, wherein the first histogram is an absolute distance histogram of a point cloud dataset.

Aspect 4: The optical ranging system of any of Aspects 1-3, wherein the first histogram is a time-domain histogram.

Aspect 5: The optical ranging system of any of Aspects 1-4, wherein the modulated optical signal is a radio frequency (RF)-encoded optical signal comprising a plurality of RF signal components, wherein each RF signal component has a different frequency.

Aspect 6: The optical ranging system of any of Aspects 1-5, wherein the modulated optical signal is an AMCW signal.

Aspect 7: The optical ranging system of any of Aspects 1-6, wherein the indirect time-of-flight sensor is configured to generate the plurality of first distance values based on respective phase differences between the reflected optical signal and a reference signal.

Aspect 8: The optical ranging system of any of Aspects 1-7, wherein each first side peak is located at a respective integer multiple of the first wavelength distance from the first histogram location of the first maximum peak, wherein each respective integer multiple is non-zero.

Aspect 9: The optical ranging system of any of Aspects 1-8, wherein the one or more processors are configured to, for each first side peak: determine an initial absolute distance of the first side peak, calculate a compensation distance by multiplying the first number of first wavelength distances that the first side peak is located from the first histogram location of the first maximum peak by the first wavelength distance, and subtract the compensation distance from the initial absolute distance to calculate the first corrected absolute distance of the first side peak.

Aspect 10: The optical ranging system of any of Aspects 1-9, wherein the one or more processors are configured to: determine a corrected three-dimensional (3D) coordinate for each measurement point in a point cloud dataset based on the first corrected histogram, and generate the point cloud based on the corrected 3D coordinate of each measurement point.

Aspect 11: The optical ranging system of any of Aspects 1-10, wherein the one or more processors are configured to, for each first side peak: determine a corrected three-dimensional (3D) coordinate for each measurement point associated with the first side peak based on the first corrected absolute distance of the first side peak, wherein each measurement point is part of a point cloud dataset, and generate the point cloud based on the corrected 3D coordinate of each measurement point.

Aspect 12: The optical ranging system of any of Aspects 1-11, wherein the plurality of first distance values correspond to a first frequency encoded onto the modulated optical signal.

Aspect 13: The optical ranging system of Aspect 12, wherein the first wavelength distance is equal to a wavelength of the first frequency.

Aspect 14: The optical ranging system of any of Aspects 1-13, wherein the indirect time-of-flight sensor is configured to generate a plurality of second distance values based on the reflected optical signal, and wherein the one or more processors are configured to: generate a second histogram based on the plurality of second distance values, detect a second maximum peak within the second histogram, detect one or more second side peaks within the second histogram that are offset from the second maximum peak, wherein each second side peak is located at least a second wavelength distance from a second histogram location of the second maximum peak, for each second side peak: calculate a second number of second wavelength distances that the second side peak is located from the second histogram location of the second maximum peak, and calculate a second corrected absolute distance of the second side peak based on the second number of second wavelength distances, generate a second corrected histogram, corresponding to the second histogram, based on the second corrected absolute distance of each second side peak, and generate the point cloud based on the first corrected histogram and the second corrected histogram.

Aspect 15: The optical ranging system of Aspect 14, wherein the plurality of first distance values correspond to a first frequency encoded onto the modulated optical signal, and wherein the plurality of second distance values correspond to a second frequency encoded onto the modulated optical signal.

Aspect 16: The optical ranging system of Aspect 15, wherein the first wavelength distance is equal to a wavelength of the first frequency, and wherein the second wavelength distance is equal to a wavelength of the second frequency.

Aspect 17: The optical ranging system of Aspect 16, wherein each first side peak is located at a first respective integer multiple of the first wavelength distance from the first histogram location of the first maximum peak, wherein each first respective integer multiple is non-zero, and wherein each second side peak is located at a second respective integer multiple of the second wavelength distance from the second histogram location of the second maximum peak, wherein each second respective integer multiple is non-zero.

Aspect 18: The optical ranging system of any of Aspects 1-17, wherein the indirect time-of-flight sensor is configured to use coherent optical detection to generate the plurality of first distance values.

Aspect 19: An optical receiver, comprising: an indirect time-of-flight sensor configured to receive a modulated optical signal from free-space, and generate a plurality of first distance values based on the modulated optical signal; and one or more processors configured to: generate a first histogram based on the plurality of first distance values, detect a first maximum peak within the first histogram, detect one or more first side peaks within the first histogram that are offset from the first maximum peak, wherein each first side peak is located at least a first wavelength distance from a first histogram location of the first maximum peak, for each first side peak: calculate a first number of first wavelength distances that the first side peak is located from the first histogram location of the first maximum peak, and calculate a first corrected absolute distance of the first side peak based on the first number of first wavelength distances, generate a first corrected histogram, corresponding to the first histogram, based on the first corrected absolute distance of each first side peak, and detect one or more objects in the free-space based on the first corrected histogram.

Aspect 20: A method of correcting point cloud errors, the method comprising: receiving a modulated optical signal from a field-of-view; generating a plurality of first distance values based on the modulated optical signal; generating a first histogram based on the plurality of first distance values; detecting a first maximum peak within the first histogram; detecting one or more first side peaks within the first histogram that are offset from the first maximum peak, wherein each first side peak is located at least a first wavelength distance from a first histogram location of the first maximum peak; for each first side peak: calculating a first number of first wavelength distances that the first side peak is located from the first histogram location of the first maximum peak; and calculating a first corrected absolute distance of the first side peak based on the first number of first wavelength distances; generating a first corrected histogram, corresponding to the first histogram, based on the first corrected absolute distance of each first side peak; and generating a point cloud based on the first corrected histogram.

Aspect 21: The method of Aspect 20, wherein the plurality of first distance values correspond to a first frequency encoded onto the modulated optical signal, and wherein the first wavelength distance is equal to a wavelength of the first frequency.

Aspect 22: A system configured to perform one or more operations recited in one or more of Aspects 1-21.

Aspect 23: An apparatus comprising means for performing one or more operations recited in one or more of Aspects 1-21.

Aspect 24: A non-transitory computer-readable medium storing a set of instructions, the set of instructions comprising one or more instructions that, when executed by a device, cause the device to perform one or more operations recited in one or more of Aspects 1-21.

Aspect 25: A computer program product comprising instructions or code for executing one or more operations recited in one or more of Aspects 1-21.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of”′ a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical ranging system, comprising:
a transmitter configured to transmit a modulated optical signal;
an indirect time-of-flight sensor configured to receive a reflected optical signal, associated with the modulated optical signal, and generate a plurality of first distance values based on the reflected optical signal; and
one or more processors configured to:
generate a first histogram based on the plurality of first distance values,
detect a first maximum peak within the first histogram,
detect one or more first side peaks within the first histogram that are offset from the first maximum peak, wherein each first side peak is located at least a first wavelength distance from a first histogram location of the first maximum peak,
for each first side peak:
calculate a first number of first wavelength distances that the first side peak is located from the first histogram location of the first maximum peak, and
calculate a first corrected absolute distance of the first side peak based on the first number of first wavelength distances,
generate a first corrected histogram, corresponding to the first histogram, based on the first corrected absolute distance of each first side peak, and
generate a point cloud based on the first corrected histogram.

2. The optical ranging system of claim 1, wherein the first maximum peak is associated with a highest density of first distance values within the first histogram.

3. The optical ranging system of claim 1, wherein the first histogram is an absolute distance histogram of a point cloud dataset.

4. The optical ranging system of claim 1, wherein the first histogram is a time-domain histogram.

5. The optical ranging system of claim 1, wherein the modulated optical signal is a radio frequency (RF)-encoded optical signal comprising a plurality of RF signal components, wherein each RF signal component has a different frequency.

6. The optical ranging system of claim 1, wherein the modulated optical signal is an amplitude-modulated continuous-wave (AMCW) signal.

7. The optical ranging system of claim 1, wherein the indirect time-of-flight sensor is configured to generate the plurality of first distance values based on respective phase differences between the reflected optical signal and a reference signal.

8. The optical ranging system of claim 1, wherein each first side peak is located at a respective integer multiple of the first wavelength distance from the first histogram location of the first maximum peak, wherein each respective integer multiple is non-zero.

9. The optical ranging system of claim 1, wherein the one or more processors are configured to, for each first side peak:
determine an initial absolute distance of the first side peak,
calculate a compensation distance by multiplying the first number of first wavelength distances that the first side peak is located from the first histogram location of the first maximum peak by the first wavelength distance, and
subtract the compensation distance from the initial absolute distance to calculate the first corrected absolute distance of the first side peak.

10. The optical ranging system of claim 1, wherein the one or more processors are configured to:
determine a corrected three-dimensional (3D) coordinate for each measurement point in a point cloud dataset based on the first corrected histogram, and
generate the point cloud based on the corrected 3D coordinate of each measurement point.

11. The optical ranging system of claim 1, wherein the one or more processors are configured to, for each first side peak:
determine a corrected three-dimensional (3D) coordinate for each measurement point associated with the first side peak based on the first corrected absolute distance of the first side peak, wherein each measurement point is part of a point cloud dataset, and
generate the point cloud based on the corrected 3D coordinate of each measurement point.

12. The optical ranging system of claim 1, wherein the plurality of first distance values correspond to a first frequency encoded onto the modulated optical signal.

13. The optical ranging system of claim 12, wherein the first wavelength distance is equal to a wavelength of the first frequency.

14. The optical ranging system of claim 1, wherein the indirect time-of-flight sensor is configured to generate a plurality of second distance values based on the reflected optical signal, and
wherein the one or more processors are configured to:
generate a second histogram based on the plurality of second distance values,
detect a second maximum peak within the second histogram,
detect one or more second side peaks within the second histogram that are offset from the second maximum peak, wherein each second side peak is located at least a second wavelength distance from a second histogram location of the second maximum peak,
for each second side peak:
calculate a second number of second wavelength distances that the second side peak is located from the second histogram location of the second maximum peak, and
calculate a second corrected absolute distance of the second side peak based on the second number of second wavelength distances,
generate a second corrected histogram, corresponding to the second histogram, based on the second corrected absolute distance of each second side peak, and
generate the point cloud based on the first corrected histogram and the second corrected histogram.

15. The optical ranging system of claim 14, wherein the plurality of first distance values correspond to a first frequency encoded onto the modulated optical signal, and
wherein the plurality of second distance values correspond to a second frequency encoded onto the modulated optical signal.

16. The optical ranging system of claim 15, wherein the first wavelength distance is equal to a wavelength of the first frequency, and
wherein the second wavelength distance is equal to a wavelength of the second frequency.

17. The optical ranging system of claim 16, wherein each first side peak is located at a first respective integer multiple of the first wavelength distance from the first histogram location of the first maximum peak, wherein each first respective integer multiple is non-zero, and
wherein each second side peak is located at a second respective integer multiple of the second wavelength distance from the second histogram location of the second maximum peak, wherein each second respective integer multiple is non-zero.

18. The optical ranging system of claim 1, wherein the indirect time-of-flight sensor is configured to use coherent optical detection to generate the plurality of first distance values.

19. An optical receiver, comprising:
an indirect time-of-flight sensor configured to receive a modulated optical signal from free-space, and generate a plurality of first distance values based on the modulated optical signal; and
one or more processors configured to:
generate a first histogram based on the plurality of first distance values,
detect a first maximum peak within the first histogram,
detect one or more first side peaks within the first histogram that are offset from the first maximum peak, wherein each first side peak is located at least a first wavelength distance from a first histogram location of the first maximum peak,
for each first side peak:
calculate a first number of first wavelength distances that the first side peak is located from the first histogram location of the first maximum peak, and
calculate a first corrected absolute distance of the first side peak based on the first number of first wavelength distances,
generate a first corrected histogram, corresponding to the first histogram, based on the first corrected absolute distance of each first side peak, and
detect one or more objects in the free-space based on the first corrected histogram.

20. A method of correcting point cloud errors, the method comprising:
receiving a modulated optical signal from a field-of-view;
generating a plurality of first distance values based on the modulated optical signal;
generating a first histogram based on the plurality of first distance values;
detecting a first maximum peak within the first histogram;
detecting one or more first side peaks within the first histogram that are offset from the first maximum peak, wherein each first side peak is located at least a first wavelength distance from a first histogram location of the first maximum peak;
for each first side peak:
calculating a first number of first wavelength distances that the first side peak is located from the first histogram location of the first maximum peak; and
calculating a first corrected absolute distance of the first side peak based on the first number of first wavelength distances;
generating a first corrected histogram, corresponding to the first histogram, based on the first corrected absolute distance of each first side peak; and
generating a point cloud based on the first corrected histogram.

21. The method of claim 20, wherein the plurality of first distance values correspond to a first frequency encoded onto the modulated optical signal, and
wherein the first wavelength distance is equal to a wavelength of the first frequency.
